(19) United States
(12) Patent Application Publication
(10) Pub. No.: US 2012/0069995 A1
(43) Pub. Date: Mar. 22, 2012

(54) CONTROLLER CHIP WITH ZEROIZABLE ROOT KEY

(75) Inventor: Donald Preston Matthews, JR., Longmont, CO (US)

(73) Assignee: SEAGATE TECHNOLOGY LLC, Scotts Valley, CA (US)

(21) Appl. No.: 12/887,586

(22) Filed: Sep. 22, 2010

(51) Int. Cl. H04L 9/00

(52) U.S. Cl. 380/44; 380/277

(57) ABSTRACT

The present invention is a data storage device that includes a control chip with a zeroizable root key. In one embodiment, the control chip comprises a digital memory, the zeroizable root key being a derived root key obtained by applying a firmware root key to a different root key stored within the digital memory such that the setting of each bit of the different root key is locked.

### FIELD OF THE INVENTION

The present invention relates generally to the field of data storage systems. In particular, the present invention relates to a controller chip configuration that enables a root key to be zeroizable.

### BACKGROUND OF THE INVENTION

There are known organizational entities that provide standards for software and hardware security. An example of such an entity is the National Institute of Standards and Technology (NIST), which has issued the Federal Information Processing Standards 140 Publication Series (FIPS 140) to coordinate the requirements and standards for cryptography modules. A FIPS 140 validation is a designation that the validated module incorporates technology that meets the FIPS 140 standards and has passed rigorous testing, for example by an accredited third-party lab. The validation serves as a standardized designation that the module is approved for securing sensitive information.

Certain security standards, including the current version of the FIPS 140 standards, require methods to zeroize cryptographic keys that operate from within the boundaries of a cryptographic module. Methods for zeroizing commonly require the cryptographic key to be modifiable or erasable. Most methods usually involve cryptographic keys that are either directly alterable or encrypted with a key that is alterable. Satisfying the zeroization requirement poses a challenge at least to data storage device control chip designs wherein a hidden root key is recorded in (e.g., burned into) a one-time programmable memory. In these circumstances, making the hidden root key alterable would require a major design change, for example, either changing the storage of the key to a multiple time programmable memory (e.g., like flash storage) or providing an ability to burn additional bits into the one-time programmable memory. Unfortunately, these solutions are either not technically practical and/or not practical in terms of added design cost.

Embodiments of the present invention provide solutions to these and other problems, and offer other advantages over the prior art.

### SUMMARY OF THE INVENTION

The present invention is a data storage device that includes a control chip with a zeroizable root key. In one embodiment, the control chip comprises a digital memory, the zeroizable root key being a derived root key obtained by applying a firmware root key to a different root key stored within the digital memory such that the setting of each bit of the different root key is locked.

### BRIEF DESCRIPTION OF THE DRAWINGS

FIG. 1 is a schematic illustration of a data storage device.

FIG. 2 is a schematic illustration of another data storage device.

FIG. 3 is a schematic flow diagram demonstrating a series of data transformations.

FIG. 4 is a block flow diagram demonstrating a series of steps carried out in relation to the data transformations shown in FIG. 3.

FIG. 5 is a schematic flow diagram demonstrating an alternative series of data transformations.

FIG. 6 is a block flow diagram demonstrating a series of steps carried out in relation to the data transformations shown in FIG. 5.

FIG. 7 is a simplified block diagram of one particular example of a data storage device.

FIG. 8 is a simplified block diagram of another particular example of a data storage device.

### DETAILED DESCRIPTION OF ILLUSTRATIVE EMBODIMENTS

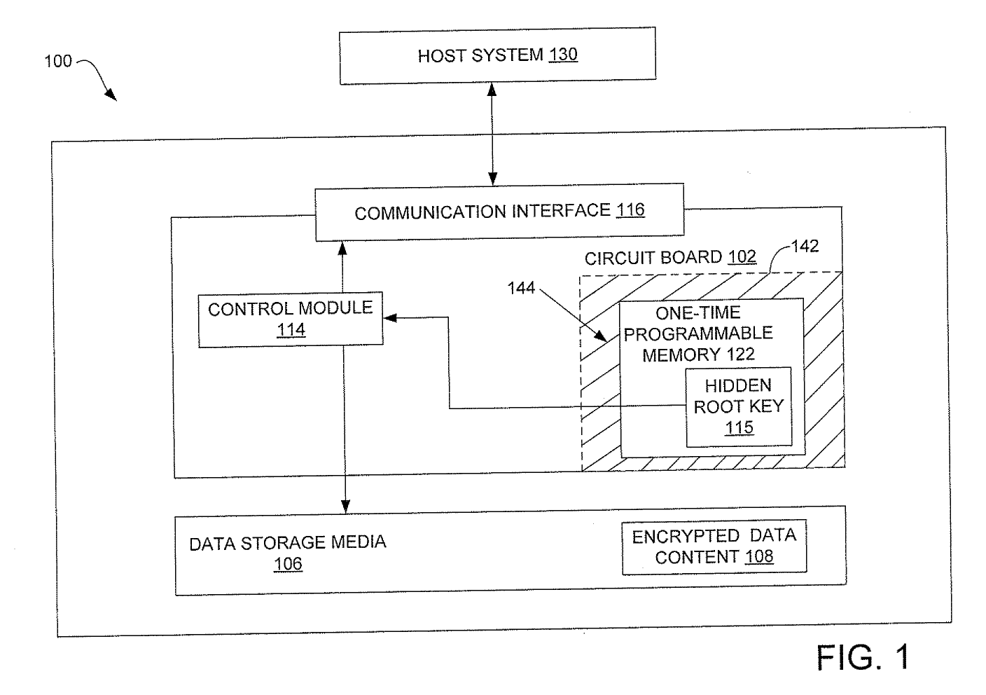

FIG. 1 is a schematic illustration of a data storage device 100, which includes circuit board 102, the control circuitry of data storage device 100. Circuit board 102 includes a control module 114. Also included is a communication interface 116, as well as a hidden root key 115 stored within a one-time programmable memory 122. In one embodiment, memory 122 is a form of digital memory wherein the setting of each bit is locked by a fuse or antifuse. Memory 122 may be, but not by limitation, a programmable read-only memory (PROM) or a field programmable read-only memory (FPROM) or a one-time programmable non-volatile memory (OTP NVM). Further, those skilled in the art will appreciate that FIG. 1 is simplified for the purpose of illustration and that memory 122 may actually be integrated into the control module 114. The scope of the present invention is not limited to the precise configuration of components as shown in the Figure.

Data storage device 100 also includes data storage media 106, which stores encrypted data content 108. In one embodiment, control module 114 uses the hidden root key 115 to encrypt some or all data content before storing it on data storage media 106 (e.g., storing is as encrypted data content 108). Control module 114 also illustratively decrypts encrypted data content (e.g., encrypted data content 108) before forwarding the data content to a host system 130 via a communication interface 116. The hidden root key 115 can also alternatively be used to encrypt/decrypt keys that are used by the control module 114 to decrypt/encrypt data 108. These are but examples of functions for which the hidden root key 115 can be applied. The scope of the present invention is not limited to any particular function for the hidden root key 115. The hidden root key 115 is illustratively a statistically unique root key; i.e., it is statistically unique to circuit board 102 and not commonly used in a multitude of circuit boards similar to circuit board 102.

In one embodiment, not by limitation, data storage media 106 is a re-writable media disc and data storage device 100 is a disc drive. In other embodiments, also not by limitation, data storage media 106 is a semiconductor memory, such as random access memory (RAM), read-only memory (ROM), non-volatile random access memory (NVRAM), electrically erasable programmable read-only-memory (EE-PROM) or FLASH memory, other magnetic media, optical media, or the like. Data storage device 100 is configured as appropriate for the applicable data storage media 106. In one embodiment, also not by limitation, data storage device 100 is a solid state data storage device that uses solid-state memory to store persistent data.

Control module 114 facilitates the sending and retrieving of data content in relation to data storage media 106. In embodiments where data storage device 100 is a disc drive, control module 114 may include a channel that converts analog signals measured by a head traversing a media disc of data storage media 106 to digital signals. In such embodiments, control module 114 converts digital data into analog signals to write to data storage media 106. Conversely, control module 114 converts analog signals read from data storage media 106 into digital data.

Control module 114 also facilitates the sending of data content to the host system 130 via communication interface 116. Control module 114 may send data content to communication interface 116 as a digital signal or as an analog signal, e.g., as an analog video signal. In some embodiments, control module 114 may also receive data content from host system 130 via communication interface 116.

Certain security standards, including the current version of the FIPS 140 standards, require methods to zeroize cryptographic keys that operate from within the boundaries of a cryptographic module. Methods for zeroizing commonly require the cryptographic key to be modifiable or erasable. Methods usually involve cryptographic keys that are either alterable or encrypted with a key that is alterable.

It is notable that there is sometimes flexibility in terms of where the boundaries of the cryptographic module are defined. With reference to data storage device 100, if the boundaries of the cryptographic module are defined as being the entire circuit board 102, then the cryptographic module includes a key (i.e., hidden root key 115) that is, generally speaking, not alterable because it is burned into one-time programmable memory 122. Altering hidden root key 115 would require a major design change, for example, either changing the storage of the key to a multiple time programmable memory (e.g., like flash storage) or providing an ability to burn additional bits into the one-time programmable memory. Unfortunately, circuit boards in a typical device 100 will lack an available multiple time programmable memory location where hidden root key 115 can practically be stored. It generally would not be cost effective or practical to add such memory without some other good rationale for doing so. The downside of burning additional bits into the one-time programmable memory include: 1) the cost of a charge pump to have the voltage required to burn the memory; and 2) the alteration of the hidden root key value with either skew the value to have more bits programmed (smaller search space therefore weakens the key) or a disable bit, which will forever remove the full disc encryption capabilities of the drive.

Given the noted challenges associated with making hidden rook key 115 zeroizable, one option is to simply adjust the boundaries of the cryptographic module. For example, the cryptographic module can be defined as all of circuit board 102 minus an area 144 within a boundary 142. In this case, the hidden root key 115 is now outside of the cryptographic module. Assuming any other key operating from within the cryptographic module is alterable or zeroizable, then the security standard is likely satisfied and certification very well may be warranted. However, the hidden root key 115 will not be part of such a certification.

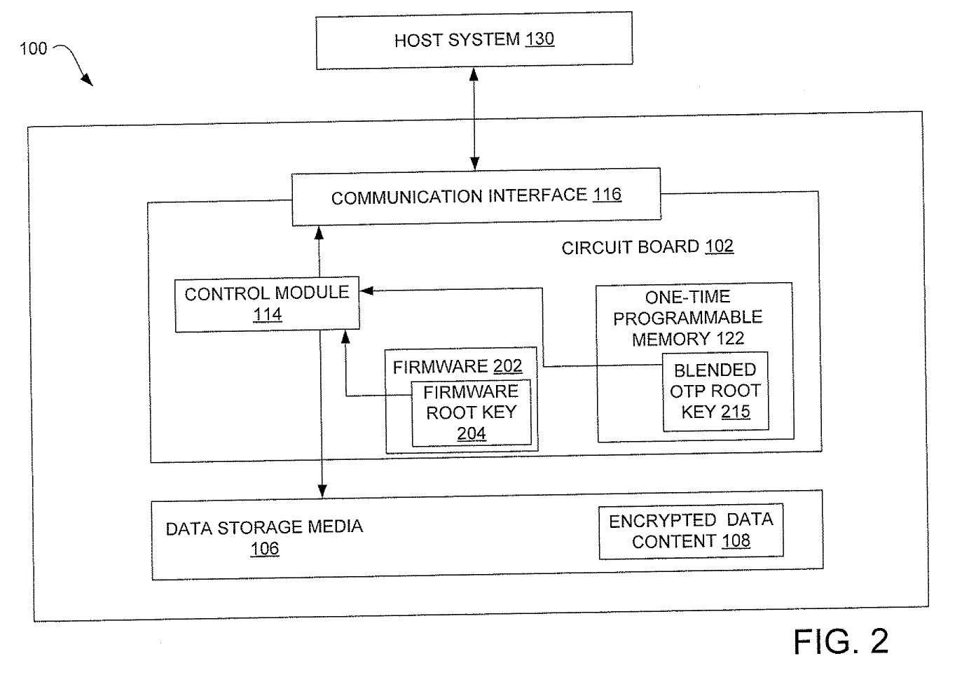

FIG. 2 is a schematic illustration of a different configuration for data storage device 100 and its associated circuit board 102. Components in FIG. 2 having same or similar reference numbers as compared to FIG. 1 are to be understood as having same or similar functionality as described with reference to FIG. 1. Notably, a blended one-time programmable (OTP) root key 215 and the one-time programmable memory 122 in which the key is stored are not identified in FIG. 2, similar to FIG. 1, within the area 144 defined by boundary 142. In one embodiment, the cryptographic module boundaries instead encompass the blended OTP root key 215. In one embodiment, also included within the boundaries are any or all of memory 122, firmware 202, firmware key 204, and control module 114. In one embodiment, the boundaries of the cryptographic module in FIG. 2 encompass all of circuit board 102 and its related components (including blended OTP root key 215). The functions of the blended OTP root key 215, firmware 202 and firmware root key 204 will be described in greater detail below.

At least for some of the reasons discussed above in relation to FIG. 1, it is assumed that it is not practically reasonable to change a key value burned into the one-time programmable memory 122. The configuration of FIG. 2 illustratively supports an alternative configuration wherein the blended OTP root key 215 is a zeroizable base root key value (e.g., it can be the hidden root key 115) that has been transformed (e.g., but not limited to, transformation by encryption) by way of a transformation based on another key that can be altered. In essence, the blended OTP root key 215 is a combination of the zeroizable base hidden root key and an alterable key. In one embodiment, the alterable key is firmware root key 204.

In accordance with one embodiment, the firmware component 202 is configured to pass firmware root key 204 to the control module 114. The control module 114 applies (e.g., but not limited to, by way of decryption) firmware root key 204 to the blended OTP root key 215 so as to derive the zeroizable base root key. The firmware 202 is illustratively configured with the capability to change the firmware key 204. Thus, the zeroizable base root key is zeroizable at least because it can be zeroed by changing or deleting firmware key 204. In other words, Destroying, deleting, or changing the firmware root key 204 will essentially terminate access to the base of the blended OTP root key 215 (e.g., the decrypted version of key 215). In the context of FIG. 1, this would be functionally similar to destroying, deleting or changing hidden root key 115. In one embodiment, the firmware 202 is also configured to itself functionally provide a level of assurance that the correct firmware key 204 was sent in and that the resulting decrypted base root key value is correct.

Notably, an attacker that gains access to firmware 202 will only be able to access to the firmware key 204. However, unless key 204 is utilized to transform (e.g., decrypt) blended OTP root key 215, security is not compromised. The circuit board 102 configuration shown in FIG. 2 is potentially FIPS 140 compliant even if the boundaries of the cryptographic module are defined so as to encompass memory 122 and/or blended OTP root key 215. In one embodiment, the circuit board of FIG. 2 is FIPS 140 compliant.

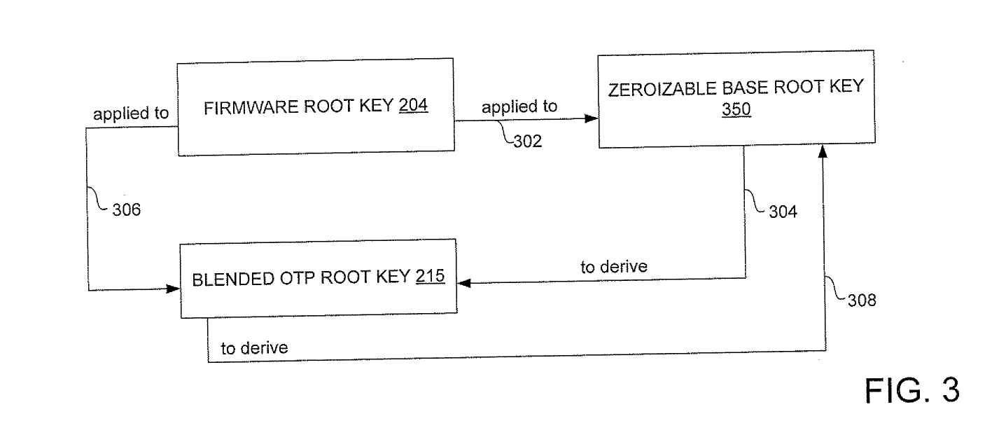

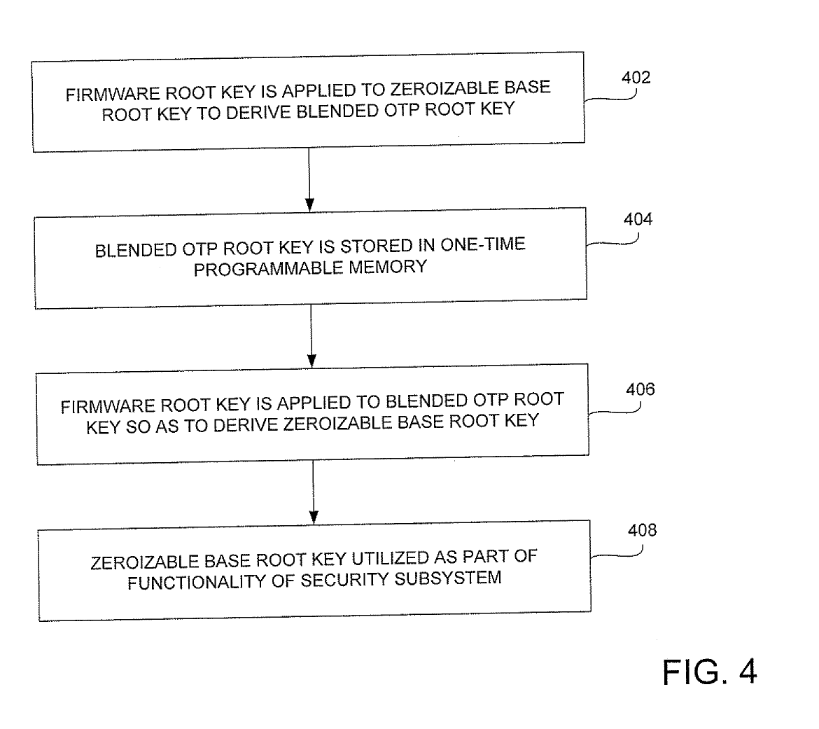

FIG. 3 is a schematic flow diagram demonstrating a series of data transformations described above in relation to FIG. 2. FIG. 4 is a block flow diagram demonstrating a series of steps carried out in relation to the transformations shown in FIG. 3.

In accordance with block 402 (also arrows 302 and 304), the firmware root key 204 (which is illustratively alterable by firmware 202) is applied (e.g., by an encryption process) to a base root key 350 (e.g., hidden root key 115) so as to derive the blended OTP root key 215. In accordance with block 404, the blended OTP root key 215 is stored in the one-time programmable memory 122. In accordance with block 406 (also arrows 306 and 308), firmware root key 204 is subsequently applied (e.g., by a decryption process) to blended OTP root key 215 so as to derive the zeroizable base root key 350. In one embodiment, the control module, after receiving the blended OTP root key 215 and the firmware root key 204, manages either or both of the described transformation processes. In accordance with block 408, the zeroizable base root key 350 is utilized as part of a security subsystem. In one embodiment, key 350 is utilized in a manner the same or similar to hidden root key 115 described above or is utilized in any other way in which a hidden root key might be utilized within a traditional data storage system.

Those skilled in the art will appreciate that the scope of the present invention is not limited to the exact transformation schemes described herein. In one embodiment, a simple one way encryption/decryption with the alterable firmware root key is utilized to encrypt and decrypt the zeroizable base root key so as to derive and un-derive the blended OTP root key. However, those skilled in the art will appreciate that other encryption schemes, such as a more complex scheme involving a public-private key pair, could be implemented without departing from the scope of the present invention. Further, multiple layers of encryption are also contemplated as a means for providing additional security. It has been described that a zeroizable root key, in one embodiment, is a zeroizable base root key that has been encrypted with a firmware root key. Those skilled in the art will appreciate that a same similar functional outcome may be accomplished through application of a decryption process, performance of a hash function, application of some other kind of one way function, etc. For all transformations disclosed herein, these types of changes in the applicable transformation processes are within the scope of the present invention.

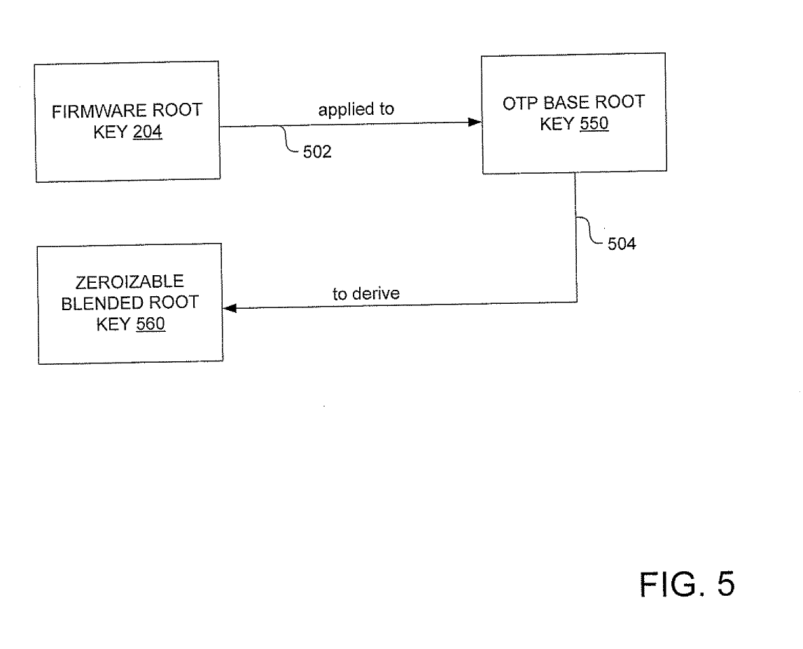

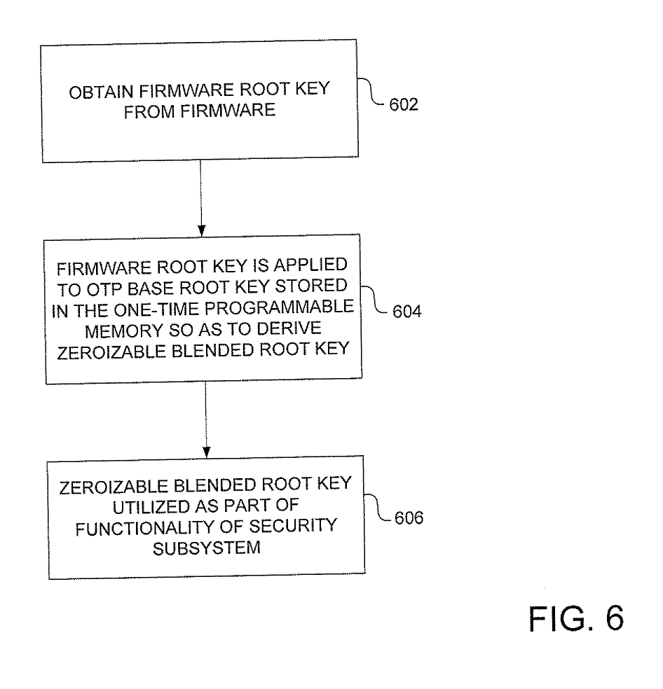

An example of another similar but different process configuration within the scope of the present invention will now be provided. FIG. 5 is a schematic flow diagram demonstrating an alternative series of data transformations. FIG. 6 is a block flow diagram demonstrating a series of steps carried out in relation to the transformations shown in FIG. 5. As will be seen, this embodiment contemplates utilizing a blended value (generated based on a derivation involving the firmware key) as the zeroizable security component rather than as a basis for generating the zeroizable security component.

In accordance with block 602, the process includes, similar to the previously described process, obtaining a firmware key 204 (e.g., obtaining from firmware 202). In accordance with block 604 (also arrows 502 and 504), the firmware root key 204 (which is illustratively alterable by firmware 202) is applied (e.g., by an encryption process) to an OTP base root key 550 so as to derive a zeroizable blended root key 560. In accordance with box 606, the zeroizable blended root key 560 is utilized as part of a security subsystem. In one embodiment, key 560 is utilized in a manner the same or similar to hidden root key 115 described above or is utilized in any other way in which a hidden root key might be utilized within a traditional data storage system.

In essence, key 550 takes the place of blended OTP root key 215 shown in FIG. 2. Key 550 is not a blended value similar to key 215 but instead is, similar to the hidden root key 115 (FIG. 1), a statistically unique root key; i.e., it is statistically unique to circuit board 102 and not commonly used in a multitude of circuit boards similar to circuit board 102. Key 550 is illustratively stored in the one-time programmable memory 122 and combined (e.g., but not limited to, by way of encryption or decryption) with key 204 to generate key 560. In one embodiment, the control module 114, after receiving the OTP base root key 550 and the firmware root key 204, manages the derivation of the zeroizable blended root key 560. This is but another example of a configuration that supports a zeroizable root key. Those skilled in the art will appreciate that the scope of the present invention is also not limited to this exact transformation scheme.

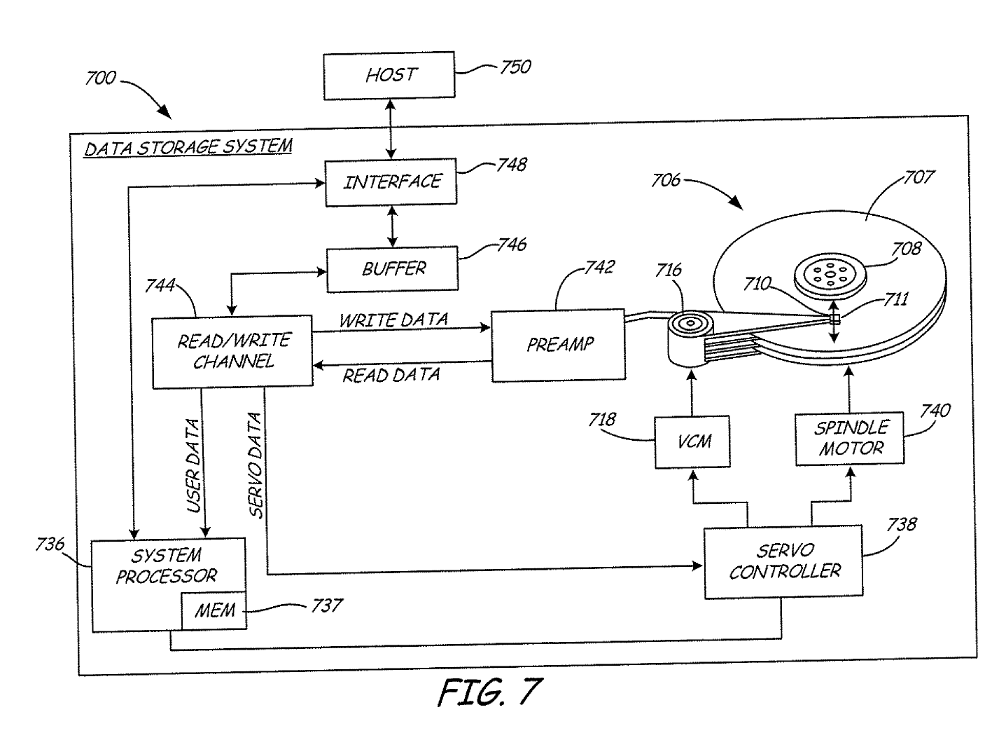

FIG. 7 is a simplified block diagram of one particular example, certainly not by limitation, of a data storage device 700 within which embodiments of the present invention may be applied. In particular, the device 700 shown in FIG. 7 is a disc drive. The device includes media 706 (e.g., similar to media 106 in FIGS. 1 and 2) in the form of a plurality of discs 707. Each disc 707 has a plurality of substantially concentric circular tracks. Each track is subdivided into a plurality of storage segments. Each storage segment is identified and located at various positions on media 706. Storage segments or data sectors are illustratively “pie-shaped” angular sections of a track that are bounded on two sides by radii of the disc and on the other side by the perimeter of the circle that defines track. Each track has related linear block addressing (LBA). LBA includes a cylinder address, head address and sector address. A cylinder identifies a set of specific tracks on the disc surfaces to each disc 707, which lie at equal radii and are generally simultaneously accessible by a collection of heads 711. The head address identifies which head can read the data and therefore identifies which disc from the plurality of discs 707 the data is located. As mentioned above, each track within a cylinder is further divided into sectors for storing data and servo information. The data sector is identified by an associated sector address.

Disc drive 700 includes system processor 736 (e.g., similar to circuit board 102 in FIGS. 1 and 2), which is used for controlling certain operations of disc drive 700 in a known manner. The various operations of disc drive 700 are controlled by system processor 736 with the use of programming stored in memory 737 (memory 737 might also include memory 122 described in relation to FIGS. 1 and 2). Disc drive 700 also includes a servo controller 738 that generates control signals applied to VCM 718 and spindle motor 740. System processor 736 instructs servo controller 738 to seek head 711 to desired tracks. Servo controller 738 is also responsive to servo data, such as servo burst information recorded on disc 707 in embedded servo fields included in the data sectors.

Disc drive 700 further includes preamplifier (preamp) 742 for generating a write signal applied to head 711 during a write operation, and for amplifying a read signal emanating from head 711 during a read operation. A read/write channel 744 receives data from system processor 706 during a write operation, and provides encoded write data to preamplifier 742. During a read operation, read/write channel 746 processes a read signal generated by preamp 742 in order to detect and decode data recorded on disc 707. The decoded data is provided to system processor 736 and ultimately through interface 748 to host computer 750. Disc drive 700, in most cases; will receive operational power from a power supply associated with the host computer 750.

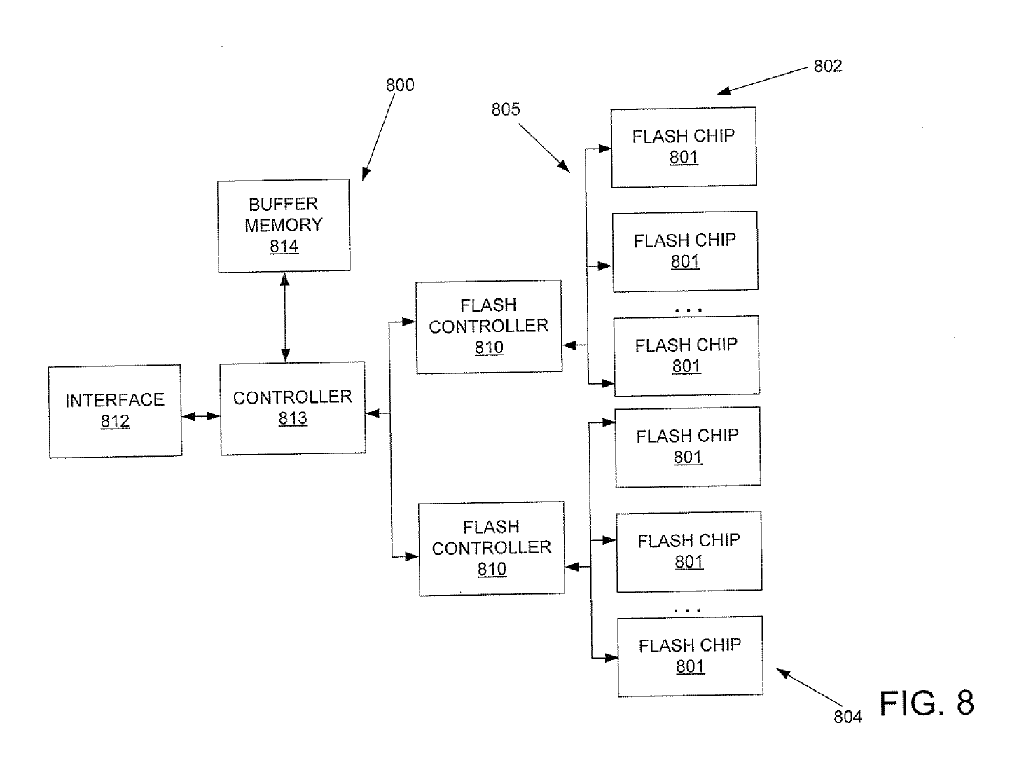

It is to be well understood that the “data storage device” described in the embodiments of schemes and systems of the present invention need not be a disc drive. FIG. 8 is a simplified block diagram of another particular example of a data storage device 800 within which embodiments of the present invention may be applied. Device 800 is a solid state data storage device. In contrast with data storage device 700 (of FIG. 7), which employs data storage media that rotate, device 800 has few or no moving parts. As can be seen in FIG. 8, device 800 includes multiple groups 802 and 804 of one or more flash memory chips, with each group including a separate flash memory controller 810. In FIG. 8, the flash memory is collectively denoted by reference numeral 805. Each flash controller 810 communicates with a device controller 813. Device controller 813 receives read/write requests via interface 812 and satisfies the requests with the help of the flash memory controllers 810 and buffer memory 814.

Devices 700 and 800 are but two of many examples of “data storage devices” that are within the scope of the present invention. Those skilled in the art will appreciate that there are certainly other alternatives within the scope of the present invention.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application of the method while maintaining substantially the same functionality without departing from the scope and spirit of the present invention. In addition, although the preferred embodiment described herein is directed to a storage system for recovering data, it will be appreciated by those skilled in the art that the teachings of the present invention can be applied to other systems without departing from the scope and spirit of the present invention.

What is claimed is:

1. A control chip with a one-time programmable memory in which is stored one of at least two root keys necessary for deriving a zeroizable root key.

2. The control chip of claim 1, wherein the root key stored in the one-time programmable memory is a one-time programmable root key.

3. The control chip of claim 1, wherein the root key stored in the one-time programmable memory is a blended one-time programmable root key.

4. The control chip of claim 1, wherein the zeroizable root key is a zeroizable blended root key.

5. The control chip of claim 1, wherein the zeroizable root key is a zeroizable base root key.

6. The control chip of claim 1, wherein the zeroizable root key is a zeroizable base root key that has been transformed based on a firmware root key.

7. The control chip of claim 1, wherein the root key stored in the one-time programmable memory is stored such that the setting of each bit of the root key is locked.

8. The control chip of claim 1, wherein each bit of the root key stored in the one-time programmable memory is locked by a fuse or antifuse.

9. The control chip of claim 1, wherein the control chip includes a control module that utilizes a firmware root key as a computational basis for processing a zeroizable base root key so as to derive a blended one-time programmable root key, the blended one-time programmable root key being the root key stored in said one-time programmable memory.

10. The control chip of claim 7, wherein the blended one-time programmable root key and the firmware root key are both stored in data storage memory mechanisms that are functionally connected to the control chip.

11. A data storage device that includes a control chip with a zeroizable root key, the zeroizable root key being a derived root key obtained by applying a firmware root key to a different root key stored within the digital memory such that the setting of each bit of the different root key is locked.

12. The device of claim 11, wherein the different root key is a blended one-time programmable root key.

13. The device of claim 1, wherein the zeroizable root key is a zeroizable blended root key.

14. The device of claim 1, wherein the zeroizable root key is a zeroizable base root key.

15. A method, comprising:
generating a zeroizable root key by applying an alterable root key to a different root key stored in a one-time programmable memory;
utilizing the zeroizable root key to encrypt or decrypt data.

16. The method of claim 15, wherein applying the alterable root key to the different root key comprises applying the alterable root key to a blended one-time programmable root key.

17. The method of claim 15, where in the alterable root key is a firmware root key obtained from a firmware component.

18. The method of claim 15, wherein changing the alterable root key causes the zeroizable root key to be altered.

19. The method of claim 15, wherein the different root key is stored in the one-time programmable memory such that each bit of the different root key is locked.

20. The apparatus of claim 13, wherein the different root key is stored in the one-time programmable memory such that each bit of the different root key is locked by a fuse or antifuse.
